(19) United States
(12) Patent Application Publication
(10) Pub. No.: US 2020/0219447 A1
(43) Pub. Date: Jul. 9, 2020

(54) IMAGE SENSOR

(71) Applicant: Ignis Innovation Inc., Waterloo (CA)

(72) Inventors: Jafar Talebzadeh, Waterloo (CA); Shuenn-Jiun Tang, Guelph (CA)

(21) Appl. No.: 16/588,924

(22) Filed: Sep. 30, 2019

Related U.S. Application Data
(60) Provisional application No. 62/790,093, filed on Jan. 9, 2019.

(51) Int. Cl. G09G 3/3258

(52) U.S. Cl. CPC G09G 3/3258; G09G 2310/0297; G09G 2320/064; G09G 2360/147

(57) ABSTRACT

Each pixel circuit in a display system includes an incident light detector circuit including a photodetector, and a switch, for measuring the luminance emitted by each light emitting device. Light detector control signals address the light detector circuits sequentially, one row at a time. The light detector circuits transmit a light detector current signal corresponding to the luminance of the corresponding light emitting device to a corresponding current integrator for conversion into a corresponding light detector voltage signal. Since a plurality of the light detector (current or voltage) signals are transmitted simultaneously, a multiplexer is provided for selecting one light detector (current or voltage) signal at a time for transmission to an analog to digital converter, which converts each light detector voltage signal into a digital signal. The digital signals may then be sent to a digital controller for modifying selected programming signals to pixels illustrating degradation.

### CROSS-REFERENCE TO RELATED APPLICATIONS

This application claims priority to U.S. Provisional Application No. 62/790,093, filed Jan. 9, 2019, which is hereby incorporated by reference herein in its entirety.

### TECHNICAL FIELD

The present invention relates to a large-area flat-panel image sensor, and in particular to an image sensor, which measures current generated by photodetectors, such as photodiodes.

### BACKGROUND

Organic light emitting diode (OLED) displays have gained significant interest recently in display applications in view of their faster response times, larger viewing angles, higher contrast, lighter weight, lower power, amenability to flexible substrates, as compared to liquid crystal displays (LCDs).

OLED displays may be created from an array of light emitting devices each controlled by individual circuits, i.e. pixel circuits, including transistors for selectively controlling the circuits to be programmed with display information, and for emitting light according to the display information. Thin film transistors (TFTs) fabricated on a substrate may be incorporated into such displays, because TFT's provide light weight, high photosensitivity and a lack of image distortion. However, TFTs tend to demonstrate non-uniform behavior across display panels and over time as the displays age. Compensation techniques may be applied to such displays to achieve image uniformity across the displays and to account for degradation in the displays as the displays age.

Some schemes, for providing compensation to displays to account for variations across the display panel and over time, utilize monitoring systems to measure time dependent parameters associated with the aging, i.e. degradation, of the pixel circuits. The measured information can then be used to inform subsequent programming of the pixel circuits to ensure that any measured degradation is accounted for by adjustments made to the programming. However, conventional monitored pixel circuits utilize pixel circuit characteristics as an indirect measurements of the light source's intensity or luminance, e.g. driving transistor current, driving transistor threshold voltage, operating voltage of light emitting device.

An object of the present invention is to overcome the shortcomings of the prior art by providing a direct measure of the luminance of the light sources, which may be converted to a digital code for use by a digital controller for compensating individual pixels.

### SUMMARY OF THE INVENTION

Accordingly, the present disclosure relates to a display comprising:

a plurality of pixels arranged in a plurality of rows and a plurality of columns, each pixel comprising a corresponding light emitting device, and a light detector circuit including a photodetector for generating a light detector current signal corresponding to a luminance of the corresponding light emitting device;

a gate driver configured to activate the light detector circuits one row of pixels at a time;

a plurality of current integrators, one current integrator for each column of pixels, for converting the light-detector current signals into light-detector voltage signals;

a multiplexer configured to sequentially select the light-detector current signals or the light-detector voltage signals from each row of pixels one light-detector current signal or one light-detector voltage signal at a time; and

an analog to digital convertor for converting the light-detector voltage signals into digital signals indicative of the luminance of the light emitting devices one light-detector voltage signal at a time.

Another aspect of the present disclosure relates to a display comprising:

a plurality of pixels arranged in a plurality of rows and a plurality of columns, each pixel comprising a corresponding light emitting device, and a light detector circuit including a photodetector for generating a light detector current signal corresponding to a luminance of the corresponding light emitting device;

a gate driver configured to simultaneously activate the light detector circuits in a first row of the plurality of rows of pixels during a first time period, and to simultaneously activate the light detector circuits in a second row of the plurality of rows of pixels during a second time period after the first time period has expired;

a plurality of current integrators, one current integrator for each column of pixels, for converting the light detector current signals into light detector voltage signals;

a multiplexer configured to sequentially selecting the light detector current signals or the light detector voltage signals from the first row of the plurality of rows of pixels one at a time during the first time period, and configured to sequentially selecting the light detector current signals or the light detector voltage signals from the second row of the plurality of rows of pixels one at a time during the second time period; and

an analog to digital convertor for converting the light detector voltage signals into digital signals indicative of the luminance of the light emitting devices.

Another feature of the present disclosure provides a method of monitoring a plurality of pixels arranged in a plurality of rows and a plurality of columns, each pixel comprising a corresponding light emitting device and a light detector circuit including a photodetector, comprising:

a) generating light-detector current signals corresponding to luminance of the corresponding light emitting devices for each pixel in one row of the plurality of rows of pixels;

b) converting the light-detector current signals into light-detector voltage signals utilizing a plurality of current integrators, one current integrator for each of the plurality of columns of pixels;

c) sequentially selecting the light-detector current signals or the light-detector voltage signals from the one row of the plurality of rows of pixels one light-detector current signal or one light-detector voltage signal at a time utilizing a multiplexer;

d) converting the light-detector voltage signals into digital signals indicative of the luminance of the light emitting devices one light-detector voltage signal at a time utilizing an analog to digital converter; and

e) repeating steps a) to d) for each of the plurality of rows of the plurality of pixels.

### BRIEF DESCRIPTION OF THE DRAWINGS

The invention will be described in greater detail with reference to the accompanying drawings which represent preferred embodiments thereof, wherein:

FIG. 1 is a schematic diagram of a display system;

FIG. 2 is a schematic diagram of a pixel of the display system of FIG. 1;

FIG. 3 is a schematic diagram of the display of FIG. 1 illustrating a light detector system;

FIG. 4 is a schematic diagram of a portion of the light detector system of FIG. 3;

FIG. 5 is a timing diagram of the light detector system of FIG. 3; and

FIG. 6 is a flow diagram illustrating a method of monitoring a plurality of pixels.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

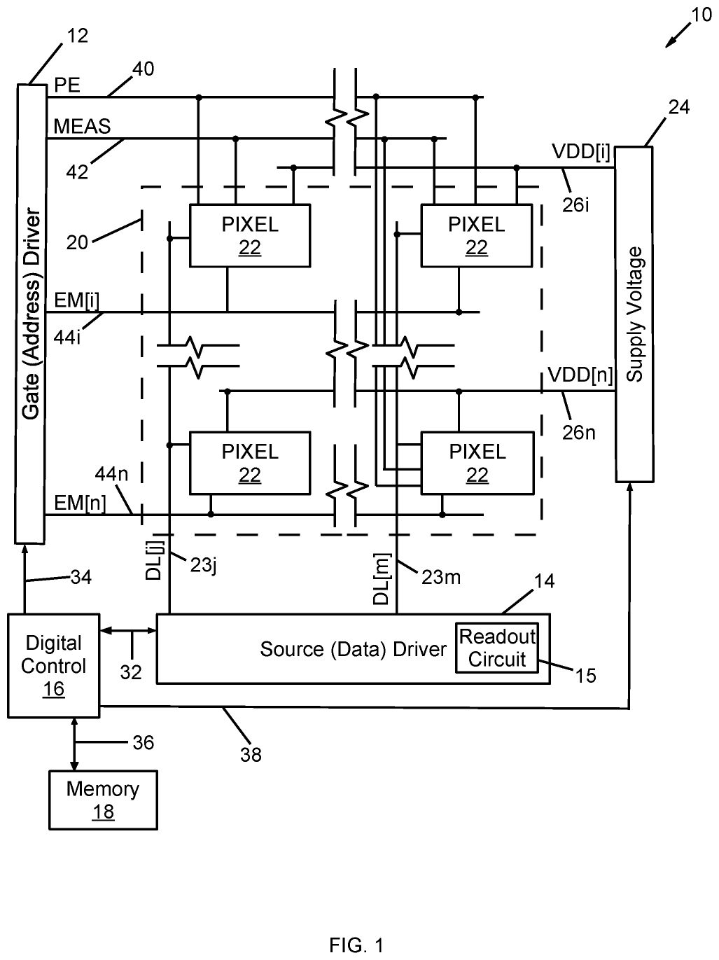

With reference to FIG. 1, an exemplary display system 10 includes a gate driver 12, a source driver 14, a digital controller 16, a memory storage 18, and a display panel 20. The display panel 20 includes an array of pixels 22 arranged in rows and columns. Each of the pixels 22 is individually programmable to emit light with individually programmable luminance values. The controller 16 receives input digital data indicative of information to be displayed on the display panel 20 from an external source. The controller 16 sends signals 32 to the source driver 14 and scheduling signals 34 to the gate driver 12 to drive the pixels 22 in the display panel 20 to display the information indicated. The plurality of pixels 22 associated with the display panel 20 comprise a display array (“display screen”) adapted to dynamically display information according to the input digital data received by the controller 16. The display screen can display, for example, video information from a stream of video data received by the controller 16. The supply voltage 24 may provide a constant power voltage or may be an adjustable voltage supply that is controlled by signals from the controller 16. The display system 10 may also incorporate features from a current source or sink (not shown) to provide biasing currents to the pixels 22 in the display panel 20 to thereby decrease programming time for the pixels 22.

For illustrative purposes, the display system 10 in FIG. 1 is illustrated with only four pixels 22 in the display panel 20; however, it is understood that the display system 10 may be implemented with a display screen that includes an array of similar pixels, such as the pixels 22, and that the display screen is not limited to a particular number of rows and columns of pixels. For example, the display system 10 can be implemented with a display screen with a number of rows and columns of pixels commonly available in displays for mobile devices, monitor-based devices, and/or projection-devices.

Each pixel 22 is operated by a driving circuit (“pixel circuit”) that generally includes a driving transistor 212, a storage device 230, and a light emitting device 214. Hereinafter the pixel 22 may refer to the pixel circuit. The light emitting device may optionally be an organic light emitting diode, but implementations of the present disclosure apply to pixel circuits having other electroluminescence devices, including current-driven light emitting devices. The driving transistor in the pixel 22 may optionally be an n-type or p-type amorphous silicon thin-film transistor, but implementations of the present disclosure are not limited to pixel circuits having a particular polarity of transistor or only to pixel circuits having thin-film transistors. The pixel circuit 22 may also include a storage capacitor for storing programming information and enabling the pixel circuit 22 to drive the light emitting device after being addressed. Thus, the display panel 20 may be an active matrix display array.

As illustrated in FIG. 1, the pixel 22 illustrated as the top-left pixel in the display panel 20 may be coupled to one or more of a power enable (PE) signal line 40, a measurement (MEAS) or compensation signal line 42, first and second supply lines 26i and 27i, a data line 23j, and an enable measurement (EM) signal line 44i. The first supply line 26i may be charged with VDD, and the second supply lines 27i may be charged with VSS.

The top-left pixel 22 in the display panel 20 may correspond to a pixel in the display panel in a “ith” row and “jth” column of the display panel 20. Similarly, the top-right pixel 22 in the display panel 20 represents a “ith” row and “mth” column; the bottom-left pixel 22 represents an “nth” row and “jth” column; and the bottom-right pixel 22 represents an “nth” row and “mth” column. Each of the pixels 22 are typically coupled with the appropriate supply lines, e.g. the first and second supply lines 26i to 26n and/or 27i to 27n, and data lines, e.g. the data lines 23j to 23m, and may be but not necessarily coupled to one of the PE signal line 40, one of the MEAS signal line 42; and EM signal lines, e.g. the EM signal lines 44i and 44n.

With reference to the top-left pixel 22 shown in the display panel 20, the PE signal line 40 and the MEAS signal line 42 are provided by the gate driver 12, and may be utilized to enable, for example, a programming operation of the pixel 22 by activating a switch or transistor 228 to enable the data line 23j to program the pixel 22. The data line 23j conveys programming information from the source driver 14 to the pixel 22. For example, the data line 23j may be utilized to apply a programming voltage or a programming current to the pixel 22 in order to program the pixel 22 to emit a desired amount of luminance. The programming voltage (or programming current) supplied by the source driver 14 via the data line 23j is a voltage (or current) appropriate to cause the pixel 22 to emit light with a desired amount of luminance according to the digital data received by the controller 16. The programming voltage (or programming current) may be applied to the pixel 22 during a programming operation of the pixel 22 so as to charge a storage device 230 within the pixel 22, such as a storage capacitor, thereby enabling the pixel 22 to emit light with the desired amount of luminance during an emission operation following the programming operation. For example, the storage device 230 in the pixel 22 may be charged during a programming operation to apply a voltage to one or more of a gate or a source terminal of the driving transistor 212 during the emission operation, thereby causing the driving transistor 212 to convey the driving current through the light emitting device 214 according to the voltage stored on the storage device.

Generally, in the pixel 22, the driving current that is conveyed through the light emitting device 214 by the driving transistor 212 during the emission operation of the pixel 22 is a current that is supplied by the supply line 26i. The first supply line 26i may provide a positive supply voltage e.g. the voltage commonly referred to in circuit design as “VDD”, and the second supply line 27i may provide a negative supply voltage (VSS).

The EM signal lines 44i to 44nn may be utilized to enable, for example, an emission operation of the pixel 22 by activating a switch or transistor 220 to enable the driving current from the driving transistor 212 to be transmitted to the light emitting device 214.

A feedback capacitor 218 may be connected between node B 224 and node A 222. Accordingly, the feedback capacitor 218 is connected between the anode terminal of the light emitting device 214 (node B) and the gate terminal of the drive transistor 212 (node A). The feedback capacitor 218 may provide a capacitive coupling between the light emitting device 214 and the gate terminal of the drive transistor 212. For example, an increase in voltage at node B 224 (due to, for example, an increase in the turn on voltage of the light emitting device) results in a corresponding increase in voltage at node A via the capacitive coupling of the feedback capacitor 218. Furthermore, variations in the voltage of the anode terminal of the light emitting device 214 (at node B 224) during a driving operation produce corresponding voltage changes at the gate terminal of the drive transistor 212 (at node A 222).

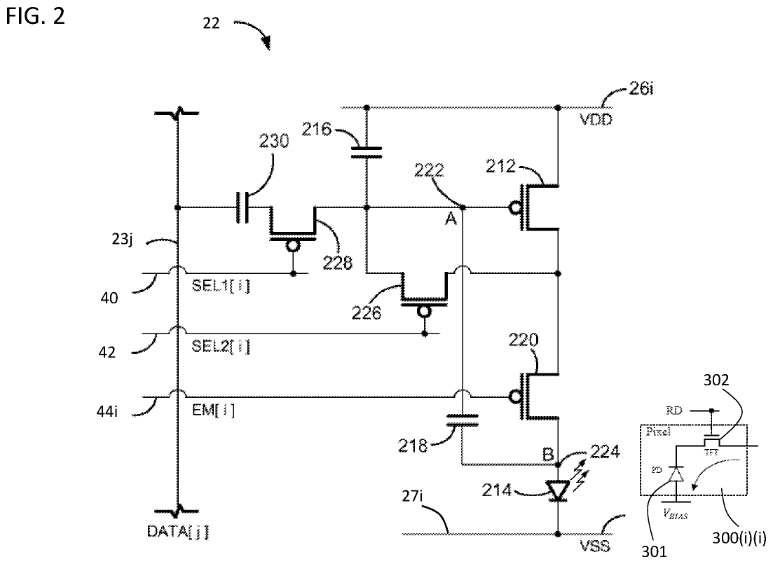

The pixel circuit 22 may but not necessarily also include a storage capacitor 216 connected to the drive transistor 212 so as to influence the conductance of the channel region of the drive transistor 212 according to the voltage charged on the storage capacitor 216. In the configuration provided in FIG. 2, the storage capacitor 216 has a first terminal connected to the gate of the drive transistor 212 at node A and a second terminal connected to the VDD power supply line 26i. In some embodiments the second terminal of the storage capacitor 216 may optionally be connected to another stable voltage, e.g. a ground voltage, a reference voltage, etc. sufficient to enable the storage capacitor 216 to be charged according to programming voltages conveyed via the data line 23i. A second switch transistor 226 may be connected to a terminal of the drive transistor 212 opposite the VDD supply line 26i (at a point between the drive transistor 212 and the emission control transistor 220) to connect and disconnect the storage capacitor 216. The second switch transistors 226 may be operated according to the second select line or MEAS line 42 to selectively connect the second terminal, e.g. the drain terminal of the drive transistor 212 to the gate terminal at node A 222. Accordingly, while the second switch transistor 226 is turned on, the second switch transistor 226 provides a current path between the voltage supply line 26i to the gate terminal (at node A 222) through the drive transistor 212. While the second switch transistor 226 is turned on, the voltage on the gate terminal at node A 222 may adjust to a voltage corresponding to a current flowing through the drive transistor 212.

The display system 10 also includes a readout circuit 15 which may be integrated with the source driver 14. With reference again to the top left pixel 22 in the display panel 20, the data line 23j may connect the pixel 22 to the readout circuit 15. The data line 23j may enable the readout circuit 15 to measure a current associated with the pixel 22 and hereby extract information indicative of a degradation of the pixel 22. Readout circuit 15 converts the associated current to a corresponding voltage. This voltage is converted into a 10 to 16 bit digital code and is sent to the digital control 16 for further processing or compensation.

With reference to FIGS. 2, 3 and 4, each pixel circuit 22 includes an incident light detector circuit 300(1)(1) to 300(n)(m) including a photodetector 301, e.g. photodiode, for measuring luminance of the light emitting device 214, and a switch 302, e.g. a thin film transistor (TFT), for selectively transmitting the measured luminance to the readout circuit 15 in the data driver 14. The digital controller 16 sends light detector control signals 305₁ to 305ₙ to the gate driver 12 to address the light detector circuits 300(1)(1) to 300(n)(m) in the display panel 20 sequentially one row of pixels 22, i.e. light emitting devices 214, at a time using RD lines RD(1) to RD(n), respectively. The light detector control signals on the RD lines RD(1) to RD(n) activate the switches 302 in each row of pixels consecutively, row by row, enabling each photodetector 301 to transmit a light detector current signal corresponding to the luminance of the corresponding light emitting device 214 via a corresponding monitor line V_{MON}(l) to V_{MON}(m), i.e. one monitor line for each column of pixels 22, to a corresponding current integrator 306₁ to 306ₘ provided in the read out circuits 15, e.g. one current integrator 306₁ to 306ₘ for each column of pixels 22. Each current integrator 306₁ to 306ₘ is configured to convert each light detector current signal into a corresponding light detector voltage signal. Each current integrator 306₁ to 306ₘ may comprise an amplifier 311 configured to receive the light detector current signal at a first input and a bias control voltage V_{B} from the controller 16 at a second input. The bias control V_{B} is a reference voltage to set the voltage Vₘₒₙ on monitor lines V_{MON}(l) to V_{MON}(m) to get a targeted or desired range of light detector current signal values. A feedback capacitor CI may be disposed between an output and the first input. A reset switch ϕᵣₑₛₑₜ may be disposed in parallel with the feedback capacitor for resetting the bias on the capacitor, i.e. discharge.

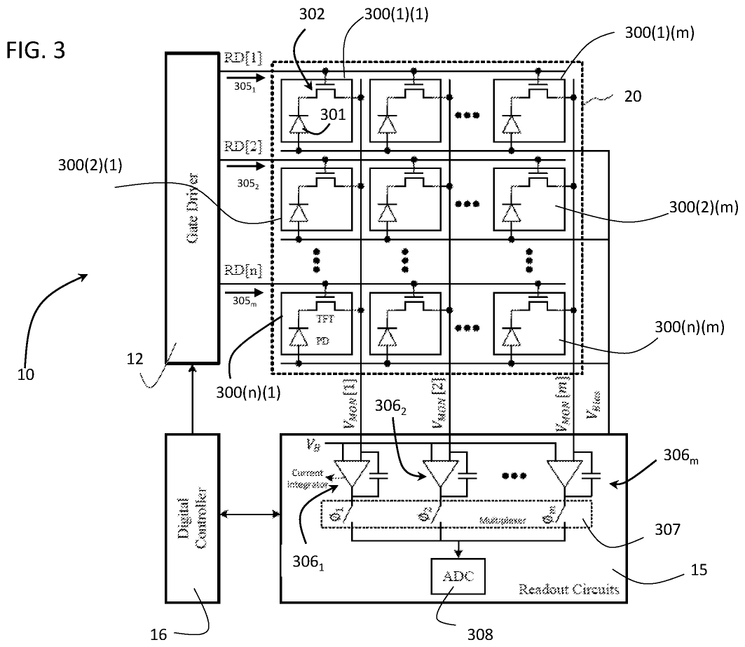

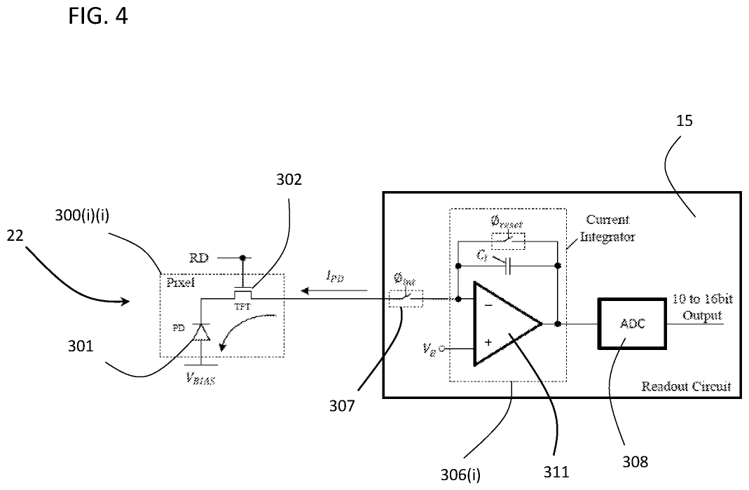

Since a plurality (m) of the light detector current signals, i.e. from an entire row of pixels 22, is transmitted simultaneously, a multiplexer 307 is provided in the read out circuits 15 for selecting one light detector current signal or one light detector voltage signal at a time for transmission to an analog to digital converter (ADC) 308, which converts each light detector voltage signal into a digital signal, e.g. 10 to 16 bit digital code. The multiplexer 307 may comprise a plurality of switches ϕ₁ to ϕₘ, i.e. one switch for each current integrator 306₁ to 306ₘ and each column. The switches ϕ₁ to ϕₘ may be positioned before (FIG. 4) or after (FIG. 3) the current integrators 306₁ to 306ₘ, i.e. for selectively passing the light detector current signals to the current integrators 306₁ to 306ₘ or the light detector voltage signals to the ADC 308.

The digital signals may then be sent to the digital controller 16 for further processing, such as authenticating that each light emitting device 214 is functioning within desired or predetermined parameters or modifying, e.g. increasing or decreasing, selected programming signals to pixels 22 not functioning within desired or predetermined parameters, e.g. illustrating degradation via lower than expected light detector current signal levels.

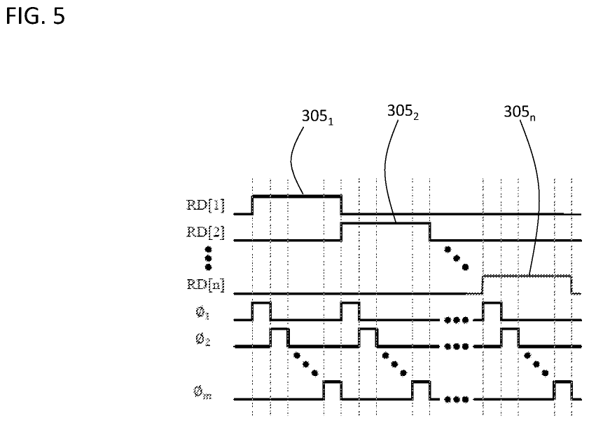

With reference to FIG. 5, the gate driver 12 transmits a first light detector control signal 305₁ via RD(1) to the first row of light detector circuits 300(1)(1) to 300(1)(m) for a duration long enough for the digital controller 16 to activate the multiplexer 307 to sequentially activate the switches ϕ₁ to ϕₘ, i.e. for m time periods, whereby each one of the light detector voltage signals from each one of the light detector circuits 300(1)(1) to 300(1)(m) from each pixel 22 in the first row of pixels is converted to a digital signal by the ADC 308. After the first light detector control signal 305₁ is turned off, the second light detector control signal 305₂ is transmitted from the gate driver 12 to activate the second row of light detector circuits 300(2)(1) to 300(2)(m) for a duration long enough for the digital controller 16 to again active the multiplexer 307 to sequentially activate the switches ϕ₁ to ϕₘ, i.e. form time periods, whereby each one of the light detector voltage signals from each one of the light detector circuits 300(2)(1) to 300(2)(m) from each pixel 22 in the second row of pixels is converted to a digital signal by the ADC 308. After each of the switches ϕ₁ to ϕₘ enables the light detector current or the light detector voltage signals from the entire row of pixels to pass, the gate driver 12 then sequentially turns off the previous light detector control signal 305ᵢ and turns on the next light detector control signal 305ᵢ₊₁ until all of the light detector current signals from all of the light detector circuits 300(1)(1) to 300(1)(m) from all of the rows of pixels 22 have been converted to digital signals.

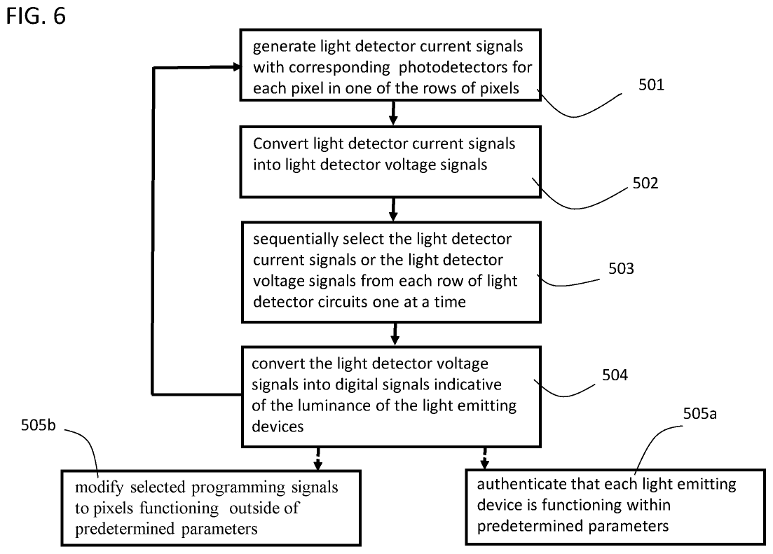

Accordingly, with reference to FIG. 6, a method of monitoring a plurality of pixels 22 arranged in a plurality of rows and a plurality of columns, in which each pixel 22 comprises a corresponding light emitting device 214, comprises a first step 501 in which a light detector current signal corresponding to a luminance of the corresponding light emitting device 214 is generated with a light detector circuit 300(i)(i) including a photodetector 301, for each pixel in one of the rows of pixels. Next, step 502, the light detector current signals are converted into light detector voltage signals utilizing a plurality of current integrators 306₁ to 306ₘ, one current integrator 306ᵢ for each column of pixels 22. Then in step 503, the light detector current signals or the light detector voltage signals are sequentially selected from each row of light detector circuits 300(i)(i) one at a time utilizing a multiplexer 307. Finally, in step 504, the light detector voltage signals are converted into digital signals indicative of the luminance of the light emitting devices 214. The method may then be repeated for each row of pixels 22, one at a time, until the light-detector current signals, the light-detector voltage signals and the corresponding digital signals have been generated and/or recorded in the digital controller 16 for each of the rows of pixels 22.

The method may further comprise step 505a, in which each light emitting device 214 is authenticated to ensure that each light emitting device 214 is functioning within predetermined parameters utilizing a digital controller 16 configured to receive the digital signals.

The method may alternatively include step 505b, in which selected programming signals for pixels 22 functioning outside of predetermined parameters are modified utilizing a digital controller 16 configured to receive the digital signals.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A display comprising:
a plurality of pixels arranged in a plurality of rows of pixels and a plurality of columns of pixels, each pixel comprising a corresponding light emitting device, and a light detector circuit including a photodetector for generating a light-detector current signal corresponding to a luminance of the corresponding light emitting device;
a gate driver configured to activate the light detector circuit from each of the plurality of pixels one row of pixels at a time;
a plurality of current integrators, one current integrator for each column of pixels, configured to convert the light-detector current signals into light-detector voltage signals from each row of pixels as the gate driver activates each row of pixels;
a multiplexer configured to sequentially select the light-detector current signals or the light-detector voltage signals one at a time from each row of pixels as the gate driver activates each row of pixels; and
an analog to digital convertor for converting the light-detector voltage signals into digital signals indicative of the luminance of the light emitting devices one light-detector voltage signal at a time.

2. The display according to claim 1, wherein the gate driver is configured to simultaneously activate the light detector circuits in a first row of the plurality of rows of pixels during a first time period; and
wherein the multiplexer is configured to sequentially select the light-detector current signals or the light-detector voltage signals from the first row of the plurality of rows of pixels one light-detector current signal or one light-detector voltage signal at a time during the first time period.

3. The display according to claim 1, wherein each light detector circuit comprises a photodiode configured to generate the light-detector current signal; and a thin film transistor configured to switch on and off a connection to one of the current integrators.

4. The display according to claim 1, wherein the multiplexer comprises a plurality of switches, one switch corresponding to each column of pixels.

5. The display according to claim 1, further comprising a digital controller configured to receive the digital signals, and authenticate that each light emitting device is functioning within predetermined parameters.

6. The display according to claim 1, further comprising a digital controller configured to receive the digital signals, and modifying selected programming signals to pixels functioning outside of predetermined parameters.

7. The display according to claim 1, wherein each current integrator comprises an amplifier configured to receive the light-detector current signal at a first input and a reference at a second input; and a feedback capacitor disposed between an output and the first input.

8. The display according to claim 7, wherein each current integrator also comprises a reset switch disposed in parallel with the feedback capacitor for resetting the capacitor.

9. A display comprising:
a plurality of pixels arranged in a plurality of rows and a plurality of columns, each pixel comprising a corresponding light emitting device, and a light detector circuit including a photodetector for generating a light-detector current signal corresponding to a luminance of the corresponding light emitting device;
a gate driver configured to simultaneously activate the light detector circuits in a first row of the plurality of rows of pixels during a first time period, and to simultaneously activate the light detector circuits in a second row of the plurality of rows of pixels during a second time period after the first time period has expired;
a plurality of current integrators, one current integrator for each column of pixels, for converting the light-detector current signals into light-detector voltage signals;
a multiplexer configured to sequentially selecting the light-detector current signals or the light-detector voltage signals from the first row of the plurality of rows of pixels one at a time during the first time period, and configured to sequentially selecting the light-detector current signals or the light-detector voltage signals from the second row of the plurality of rows of pixels one at a time during the second time period; and
an analog to digital convertor for converting the light-detector voltage signals into digital signals indicative of the luminance of the light emitting devices.

10. The display according to claim 9, wherein each light detector circuit comprises a photodiode configured to generate the light-detector current signals; and a thin film transistor configured to switch on and off a connection to one of the current integrators.

11. The display according to claim 9, wherein the multiplexer comprises a plurality of switches, one switch corresponding to each column of pixels.

12. The display according to claim 9, further comprising a digital controller configured to receive the digital signals, and authenticate that each light emitting device is functioning within predetermined parameters.

13. The display according to claim 1, further comprising a digital controller configured to receive the digital signals, and modifying selected programming signals to pixels functioning outside of predetermined parameters.

14. The display according to claim 1, wherein each current integrator comprises an amplifier configured to receive the light-detector current signal at a first input and a reference at a second input; and a feedback capacitor disposed between an output and the first input.

15. The display according to claim 14, wherein each current integrator also comprises a reset switch disposed in parallel with the feedback capacitor for resetting the capacitor.

16. A method of monitoring a plurality of pixels arranged in a plurality of rows of pixels and a plurality of columns or pixels, each pixel comprising a corresponding light emitting device and a corresponding light detector circuit including a corresponding photodetector, comprising:
a) generating light-detector current signals corresponding to luminance of the corresponding light emitting devices for each pixel in one row of the plurality of rows of pixels with the corresponding photodetectors;
b) converting the light-detector current signals into light-detector voltage signals utilizing a plurality of current integrators, one current integrator for each of the plurality of columns of pixels;
c) sequentially selecting the light-detector current signals or the light-detector voltage signals from the one row of the plurality of rows of pixels one light-detector current signal or one light-detector voltage signal at a time utilizing a multiplexer;
d) converting the light-detector voltage signals into digital signals indicative of the luminance of the light emitting devices one light-detector voltage signal at a time utilizing an analog to digital converter; and
e) repeating steps a) to d) for each of the plurality of rows of pixels.

17. The method according to claim 16, wherein the light detector circuits are simultaneously activated in a first row of the plurality of rows of pixels during a first time period; and
wherein the multiplexer sequentially selects the light-detector current signals or the light-detector voltage signals from the first row of the plurality of rows of pixels one at a time during the first time period.

18. The method according to claim 16, wherein each light detector circuit comprises a photodiode configured to generate the light-detector current signals; and a thin film transistor configured to switch on and off a connection to one of the current integrators.

19. The method according to claim 16, further comprising authenticating that each light emitting device is functioning within predetermined parameters utilizing a digital controller configured to receive the digital signals.

20. The method according to claim 16, further comprising modifying selected programming signals to pixels functioning outside of predetermined parameters utilizing a digital controller configured to receive the digital signals.
